(19) United States
(12) Patent Application Publication
(10) Pub. No.: US 2008/0238292 A1
(43) Pub. Date: Oct. 2, 2008

(54) PLASMA DISPLAY PANEL AND METHOD FOR PRODUCING THE SAME

(76) Inventors: Hiroki Yamamoto, Hitachi (JP); Takashi Naito, Funabashi (JP); Yuichi Sawai, Miyazaki (JP); Motoyuki Miyata, Hitachinaka (JP); Fusao Hojo, Tokai (JP); Keiichi Kanazawa, Ome (JP); Takashi Fujimura, Mobara (JP); Mitsuo Hayashibara, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/020,891

(22) Filed: Jan. 28, 2008

(30) Foreign Application Priority Data
Mar. 30, 2007 (JP) 2007-090539

(51) Int. Cl. H01J 63/04

(52) U.S. Cl. 313/493

(57) ABSTRACT

A plasma display panel comprising a front substrate and a back substrate formed opposite each other and bonded to each other at the peripheries, electrodes formed on the front substrate, a dielectric layer formed on the electrodes, a protective layer formed on the dielectric layer, another electrode and another dielectric layer formed on the back substrate, barrier ribs to keep spaces between the front substrate and the back substrate, and fluorescent materials packed in the spaces formed by the barrier ribs, the front substrate, and the back substrate. The barrier ribs include glass at least containing oxide of tungsten, phosphorus, barium, and vanadium.

### CLAIM OF PRIORITY

The present application claims priority from Japanese application serial No. 2007-90539, filed on Mar. 30, 2007, the content of which is hereby incorporated by reference into this application.

### FIELD OF THE INVENTION

The present invention relates to a plasma display panel and a method for producing the plasma display panel.

### BACKGROUND OF THE INVENTION

A plasma display panel (hereunder abbreviated as “PDP”) is developed, produced, and is universally prevalent as a recent flat visual display unit having a large-screen and a high-definition. In a PDP, fluorescent materials having three colors of R, G, and B, respectively, are applied between barrier ribs formed between a top plate and a back plate, ultraviolet rays are emitted by ionizing xenon gas sealed in the panel, the fluorescent materials are illuminated with the ultraviolet rays, and thereby an image is displayed.

A low melting glass material containing lead (Pb) is currently used as barrier ribs to separate fluorescent materials. Barrier ribs are produced by firstly forming a lead-based glass frit thick film and then forming the shape of the barrier ribs by sandblasting. Consequently, Pb-contained glass is discarded in large quantities and the loads on the environment increases. For that reason, a glass material, containing bismuth, zinc, or vanadium, substituted for lead glass is studied.

Another challenge of an existing PDP is the improvement of contrast. Factors influencing the lowering of contrast caused by a partition wall material are the whiteness of the partition wall material on the side of the top plate and the utilization efficiency of the emission from a fluorescent material toward the back surface. It is desirable that the color of the part, touching the top plate, of the top surface of the partition wall is black in order to improve the black contrast of the partition wall material on the top plate side. Further, the light emitted from a fluorescent material spreads around the fluorescent material and hence the light emits also on the back surface side that has nothing to do with image display. Consequently, it is desirable to enhance the reflectance of the side surface of the partition wall material in order to emit fluorescent light on the side of the top plate with a high degree of efficiently.

Glass materials containing bismuth, tin-zinc, etc. as the main components have been developed as glass materials substituted for a lead-based partition wall material (JP-A Nos. 342044/2006 and 312568/2006 for example).

However, although bismuth-based glass is not against the environmental regulations enforced in Europe and others, the material has still heavy environmental loads. Further, in the case of bismuth-based glass or tin-phosphorus-zinc-based glass, the end surface has a white color and hence black contrast is hardly improved.

An object of the present invention is to provide: a PDP that does not contain lead or bismuth and has barrier ribs of small environmental loads; and a method for producing the PDP.

### SUMMARY OF THE INVENTION

The present invention is a PDP including a front substrate and a back substrate formed opposite each other and bonded to each other at the peripheries, electrodes formed on the front substrate, a dielectric layer formed on the electrodes, a protective layer formed on the dielectric layer, another electrode and another dielectric layer formed on the back substrate, barrier ribs to keep spaces between the front substrate and the back substrate, and fluorescent materials packed in the spaces formed by the barrier ribs, the front substrate, and the back substrate, wherein the barrier ribs include glass at least containing oxide of tungsten, phosphorus, barium, and vanadium.

In a PDP according to the present invention, a preferable electrical resistivity of the barrier ribs is in the range of 10⁷ to 10¹¹ Ωcm and further a preferable height of the barrier ribs is in the range of 100 μm to 500 μm.

The present invention is a PDP including a front substrate and a back substrate formed opposite each other and bonded to each other at the peripheries, electrodes formed on the front substrate, a dielectric layer formed on the electrodes, a protective layer formed on the dielectric layer, another electrode and another dielectric layer formed on the back substrate, barrier ribs to keep spaces between the front substrate and the back substrate, and fluorescent materials packed in the spaces formed by the barrier ribs, the front substrate, and the back substrate, wherein the barrier ribs include glass containing oxide of 25 to 60 wt % WO₃, 15 to 40 wt % P₂O₅, 8 to 30 wt % BaO, and 8 to 20 wt % V₂O₅ in oxide equivalent.

In a PDP of this configuration, the partition wall material can further contain 0 to 5 wt % MoO₃, 0 to 5 wt % Cr₂O₃, 0 to 10 wt % ZrO₂, 0 to 3 wt % HfO₂, 0 to 3 wt % Gd₂O₃, and 0 to 3 wt % Al₂O₃ in oxide equivalent.

The present invention is a PDP including a front substrate and a back substrate formed opposite each other and bonded to each other at the peripheries, electrodes formed on the front substrate, a dielectric layer formed on the electrodes, a protective layer formed on the dielectric layer, another electrode and another dielectric layer formed on the back substrate, barrier ribs to keep spaces between the front substrate and the back substrate, and fluorescent materials packed in the spaces formed by the barrier ribs, the front substrate, and the back substrate, wherein: the barrier ribs include a base material and a thin film formed on the side surfaces thereof; the base material includes glass at least containing oxide of tungsten, phosphorus, barium, and vanadium; and the thin film includes at least one kind selected from among iron oxide, chromium oxide, composite oxide of iron and gallium, tantalum nitride, silicon, and germanium.

In a PDP of this configuration, a preferable refractive index of the thin film is 2.3 or more in the wavelength range of 400 nm to 800 nm.

The present invention is a PDP including a front substrate and a back substrate formed opposite each other and bonded to each other at the peripheries, electrodes formed on the front substrate, a dielectric layer formed on the electrodes, a protective layer formed on the dielectric layer, another electrode and another dielectric layer formed on the back substrate, barrier ribs to keep spaces between the front substrate and the back substrate, and fluorescent materials packed in the spaces formed by the barrier ribs, the front substrate, and the back substrate, wherein: the barrier ribs include a base material and a thin film formed on the side surfaces thereof; and the thin film includes at least one kind selected from among iron oxide, chromium oxide, composite oxide of iron and gallium, tantalum nitride, silicon, and germanium.

The present invention is a PDP including a front substrate and a back substrate formed opposite each other and bonded to each other at the peripheries, electrodes formed on the front substrate, a dielectric layer formed on the electrodes, a protective layer formed on the dielectric layer, another electrode and another dielectric layer formed on the back substrate, barrier ribs to keep spaces between the front substrate and the back substrate, and fluorescent materials packed in the spaces formed by the barrier ribs, the front substrate, and the back substrate, wherein the bottom surface and the side surface of each of the barrier ribs are integrated.

In a PDP of this configuration, it is preferable: that the barrier ribs are formed into a lattice pattern to form pixels; and that a thin film is formed on the bottom surface and the side surface of each of the barrier ribs and the thin film includes at least one kind selected from among iron oxide, chromium oxide, composite oxide of iron and gallium, tantalum nitride, silicon, and germanium.

The present invention is a method for producing a PDP, the method comprising the steps of: forming a glass thick film at least containing oxide of tungsten, phosphorus, barium, and vanadium on a back plate; and transcribing a partition wall shape on the glass by pressing a die, which is formed into the female shape of the barrier ribs and can be heated by electrification, against the glass.

Further, in the above production method, it is preferable that the method, after the step of transcribing a partition wall shape on the glass, includes the steps of further: forming a mask on the top end surfaces of the barrier ribs; and removing the mask after a thin film is formed on the inner surfaces of the barrier ribs.

By the present invention, since barrier ribs including lead- or bismuth-based glass or the like are not used and the amount of wastes is reduced in the production steps, it is possible to provide a PDP of low environmental loads. Further, by a method for producing a PDP according to the present invention, the problem such as warping of a panel glass caused by the use of electrical heating on the occasion of the forming of barrier ribs can be solved.

By the present invention, since tungsten-phosphorus-barium-vanadium-based glass is used as the material for barrier ribs, it is possible to appropriately control the electrical resistivity of the barrier ribs in the range of 10⁷ to 10¹¹ Ωcm. Thereby it is possible to obtain the effects that abnormal electrical discharge caused by residual electric charge accumulated in the barrier ribs can be suppressed and a PDP that has an appropriate wall electrical charge amount on the occasion of display and hardly causes abnormal display can be provided. Further, it is possible to provide a PDP excellent in black contrast when it is viewed from the top surface of a front plate.

Furthermore, the light emitted from a fluorescent material toward a back surface can be radiated toward a front plate by forming a thin film of a high refractive index only on the side surface portions of barrier ribs and thereby it is possible to provide a PDP having a high efficiency and a high luminance.

### BRIEF DESCRIPTION OF THE DRAWINGS

FIG. 1 is a schematic view showing a section of a PDP produced according to the present invention;

FIG. 2 is a view showing a step of forming an electrode in a PDP produced according to the present invention;

FIG. 3 is a view showing a step of forming barrier ribs and sealing glass in a PDP produced according to the present invention;

FIG. 4 is another view showing a step of forming barrier ribs and sealing glass in a PDP produced according to the present invention;

FIG. 5 is a view showing a part of a step of forming barrier ribs in a PDP produced according to the present invention;

FIG. 6 is a view showing another part of a step of forming barrier ribs in a PDP produced according to the present invention;

FIG. 7 is a view showing yet another part of a step of forming barrier ribs in a PDP produced according to the present invention;

FIG. 8 is a view showing a step of applying a fluorescent material in a PDP produced according to the present invention;

FIG. 9 is a view showing a step of baking a fluorescent material in a PDP produced according to the present invention;

FIG. 10 is a schematic view showing a section of another PDP produced according to the present invention;

FIG. 11 is a view showing a part of a step of forming a thin film in a PDP produced according to the present invention;

FIG. 12 is a schematic view showing a masking material used in the forming of a thin film according to the present invention;

FIG. 13 is a view showing another part of a step of forming a thin film in a PDP produced according to the present invention;

FIG. 14 is a view showing yet another part of a step of forming a thin film in a PDP produced according to the present invention;

FIG. 15 is a view showing a step of baking a fluorescent material in a PDP produced according to the present invention;

FIG. 16 is a graph showing spectral reflectance curves of partition wall materials according to the present invention in the visible light region;

FIG. 17 is a graph showing the wavelength dispersion characteristics of refractive indexes of thin films formed on partition wall materials in the visible light region;

FIG. 18 is a graph showing the wavelength dispersion characteristics of attenuation coefficients of thin films formed on partition wall materials in the visible light region;

FIG. 19 is a graph showing the wavelength dispersion characteristics of the refractive index of glass for a partition wall base material used in the present invention;

FIG. 20 is a graph showing the wavelength dispersion characteristics of the attenuation coefficient of glass for a partition wall base material used in the present invention;

FIG. 21 is a graph showing the change of a reflectance in response to a refractive index of a thin film; and

FIG. 22 is a schematic view showing a section of a conventionally used ordinary PDP.

### DETAILED DESCRIPTION OF THE PREFERRED EMBODIMENTS

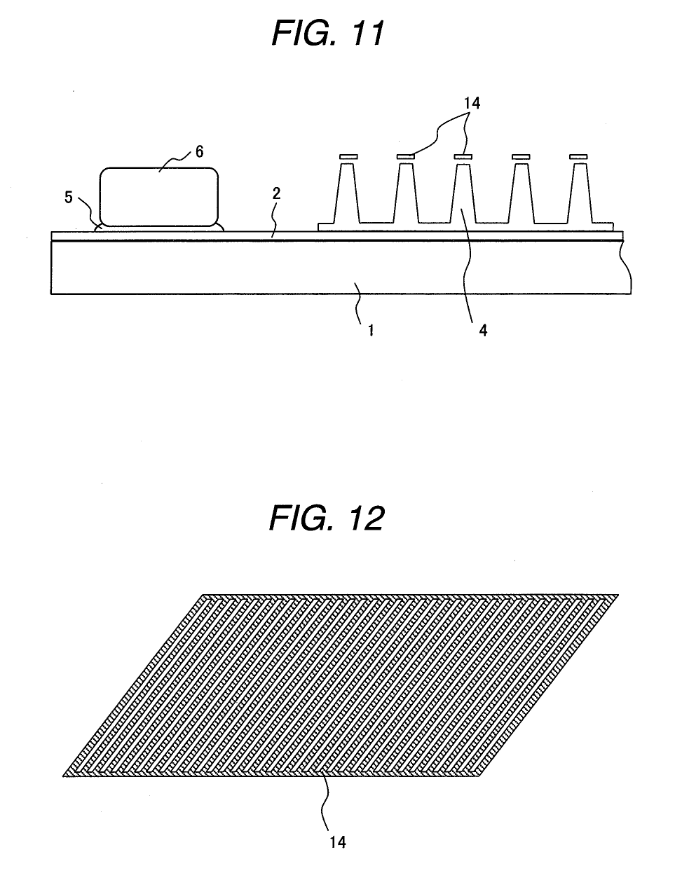

A schematic view showing a section of a PDP produced according to the present invention is shown in FIG. 10. The light emitted from a fluorescent material 3 toward a back surface can be radiated toward a front plate by using tungsten-phosphorus-barium-vanadium-based glass as the base material for barrier ribs 4 and forming a thin film 13 having a high refractive index only on the side surfaces and the bottom surfaces of the barrier ribs 4, the thin film 13 including iron oxide, chromium oxide, composite oxide of iron and gallium, tantalum nitride, silicon, or germanium, and thereby it has been possible to obtain a PDP excellent in white luminance and black contrast.

Embodiments are hereunder explained in detail.

### Embodiment 1

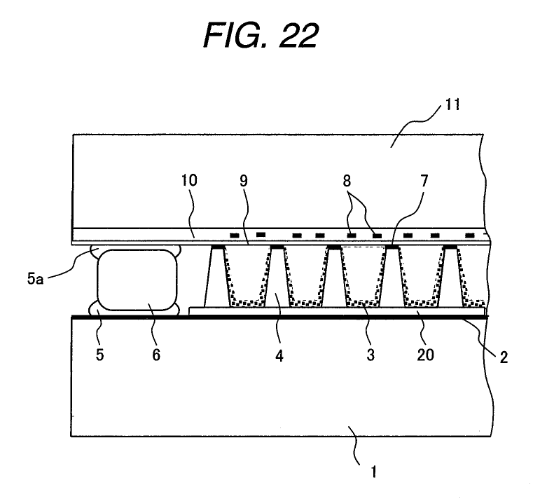

FIG. 22 is a schematic view showing a section of a conventional PDP. In FIG. 22, the reference numeral 1 represents a back substrate, 2 represents data electrodes, 3 represents fluorescent materials, 4 represents barrier ribs, 5 and 5a represent sealing glass, 6 represents frame glass, 7 represents bus electrodes, 8 represents display electrodes, 9 represents a protective film, 10 and 20 represent dielectric layers, and 11 represents a front substrate.

A PDP device is a display device to make fluorescent materials packed in spaces emit light by discharging electricity in fine spaces filled with an inert gas such as neon or xenon. In a PDP, the front substrate 11 and the back substrate 1 face each other with a gap of about 100 to 200 μm in between and the gap between the substrates is kept with the barrier ribs 4. The peripheries of the substrates are sealed with an adhesive mainly composed of glass and the interior is filled with an inert gas. Each of the fine spaces partitioned with the substrates and the barrier ribs is called a cell and each cell is filled with a fluorescent material having any one of the three colors of R (red), G (green), and B (blue) (hereunder referred to as “RGB”), and the cells of three different colors constitute a pixel and emit the light of three colors respectively.

Electrodes are regularly aligned on each of the substrates, voltage of 100 to 200 volts is applied selectively between the pair of each of the electrodes on the front substrate and the relevant electrode on the back substrate in response to display signals, ultraviolet rays are generated by electric discharge between the paired electrodes, thus the fluorescent materials are made to emit light, and thereby picture information is displayed.

Data electrodes (or called address electrodes) are formed on the back substrate of a PDP. The data electrodes include Cr—Cu—Cr wires, silver wires, or the like. The electrodes are formed by a printing method or a sputtering method.

Address discharge is activated between the address electrode and the display electrode of a cell to be lightened and wall electric charge is accumulated in the cell. Successively, by applying a prescribed voltage to the display electrode pair, display discharge occurs only in the cell wherein the wall electric charge is accumulated in the address discharge, ultraviolet rays are generated, and information is displayed on the plasma display panel.

A dielectric layer is formed on the data electrodes. The dielectric layer is formed in order to control the electric current of the address electrodes and protect the device from dielectric breakdown. Barrier ribs having openings in a stripe shape, a lattice shape or the like are formed on the dielectric layer. The barrier ribs take a linear shape (a stripe shape or a rib shape), a lattice shape wherein each pixel is partitioned with the barrier ribs, or the like. The barrier ribs are formed by a method of applying glass paste by printing, a method of shaving a thick film by sandblasting, or another method. Each of the cells partitioned with the barrier ribs is filled with a fluorescent material of one of the three colors and the wall surfaces are coated with the fluorescent material.

Meanwhile, display electrodes are formed on the front substrate. Each of the display electrodes includes a transparent electrode and a bus electrode. The transparent electrodes include an indium-tin oxide film (an ITO film) or the like and the bus electrodes include Cr—Cu—Cr wires, silver wires, or the like. The display electrodes are placed so as to be perpendicular to the data electrodes formed on the back substrate. On those electrodes, a dielectric layer that protects the electrodes, forms wall electric charge during electric discharge, and has the function of a memory is formed. On the dielectric layer, a protective layer to protect the electrodes and others against plasma is formed. An MgO film is generally formed as the protective layer. In an ordinary PDP, further a black layer (a black matrix) having an opening corresponding to each pixel is formed on the side of the front substrate. Since the black color is visible from the side of the front substrate, the effect of improving the contrast of a picture is obtained. The black layer may be formed either above or under the data electrodes.

The back substrate and the front substrate are positioned face-to-face with accuracy and the peripheries are bonded. A glass adhesive is used as the adhesive. A gas in the interior is evacuated while the interior is heated and an inert gas is introduced. Voltage is applied to a data electrode and a display electrode at the intersection thereof, thereby electricity is discharged in the inert gas, and resultantly a plasma state is formed. A fluorescent material emits light by using ultraviolet rays generated when the inert gas in the plasma state returns to an original state.

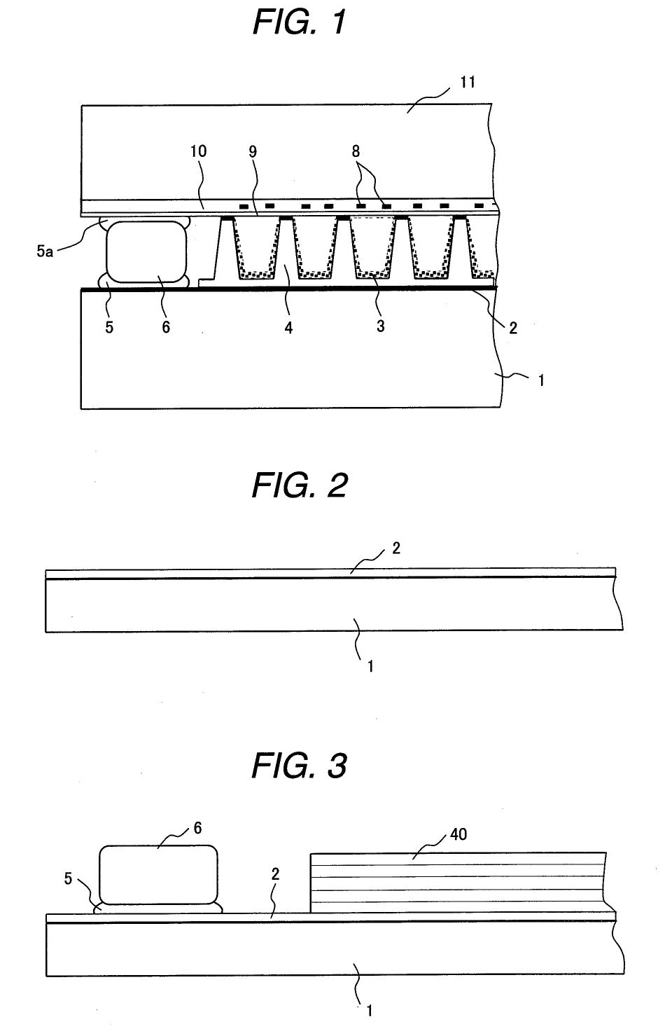

A sectional view of a PDP according to an embodiment of the present invention is shown in FIG. 1. The PDP according to the present embodiment does not contain a black matrix that has been contained in a conventional PDP shown in FIG. 22. Further, the dielectric layer 20 is integrated with barrier ribs.

A method for producing the PDP shown in FIG. 1 is explained in detail in reference to FIGS. 2 to 9.

Firstly, a data electrode 2 is formed on a back substrate 1 by a sputtering method. In the present embodiment, a soda lime glass is used as the back substrate 1 and a Cr—Cu—Cr sputter film is used as the data electrode. Here, as the data electrode (or called an address electrode), besides the above material, silver or a substance produced by mixing electrically conductive glass paste with silver may be used.

Successively, the data electrode is formed into an electrode structure by a photolithography method (FIG. 2).

Successively, in order to fix a frame, a low-temperature-softening glass frit as a frame glass 6 and a partition wall material paste 40 as the precursor of barrier ribs 4 are formed by coating. A nonlead glass is used as the glass constituting the frame glass 6 and the barrier ribs. As the frame glass 6, a vanadium-phosphorus-antimony-barium-based glass containing SiO₂ as a frit is used. Then for the barrier ribs 4, a frit of a tungsten-phosphorus-barium-vanadium-based glass that will be studied in detail later in Embodiment 2 is used (FIG. 3).

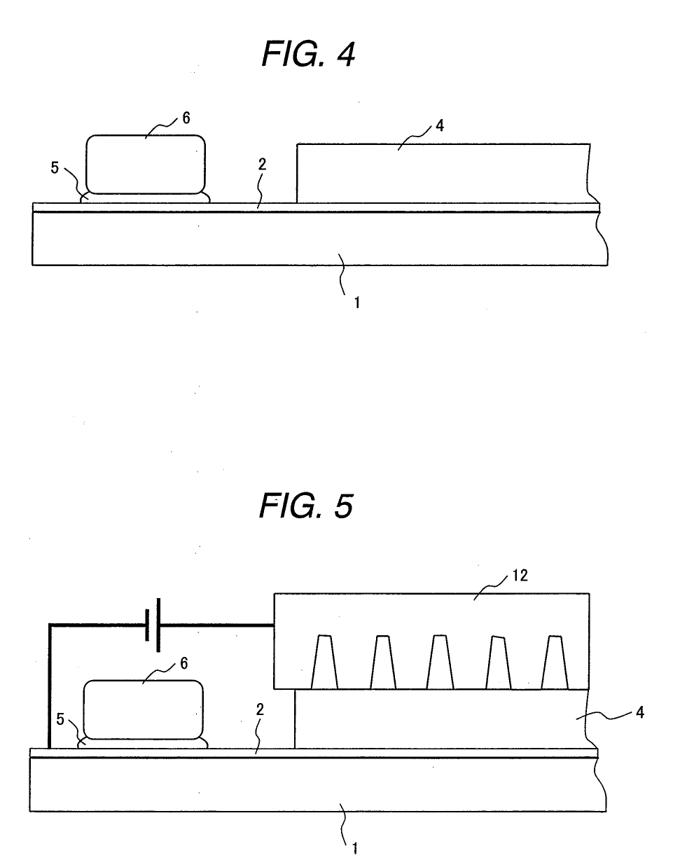

Thereafter, the materials are baked and fixed at a temperature at which the frame glass 6 and the partition wall glass soften. In the present embodiment, the baking temperature is set at 580° C. (FIG. 4).

An electrical heating method is used for forming the baked partition wall 4 into the shape of barrier ribs in the present invention. The tungsten-phosphorus-barium-vanadium-based glass used here has electrical resistance of about 10⁷ to 10¹¹ Ωcm at room temperature. However, when the glass is heated, the electrical resistance lowers because of the semiconductor-like electron conductivity and lowers up to about 10 kΩcm at 200° C. By applying DC voltage to the glass and electrifying the partition wall 4 and a die 12 formed beforehand into the female shape of the barrier ribs, the partition wall 4 is electrically heated to a temperature above the softening temperature thereof.

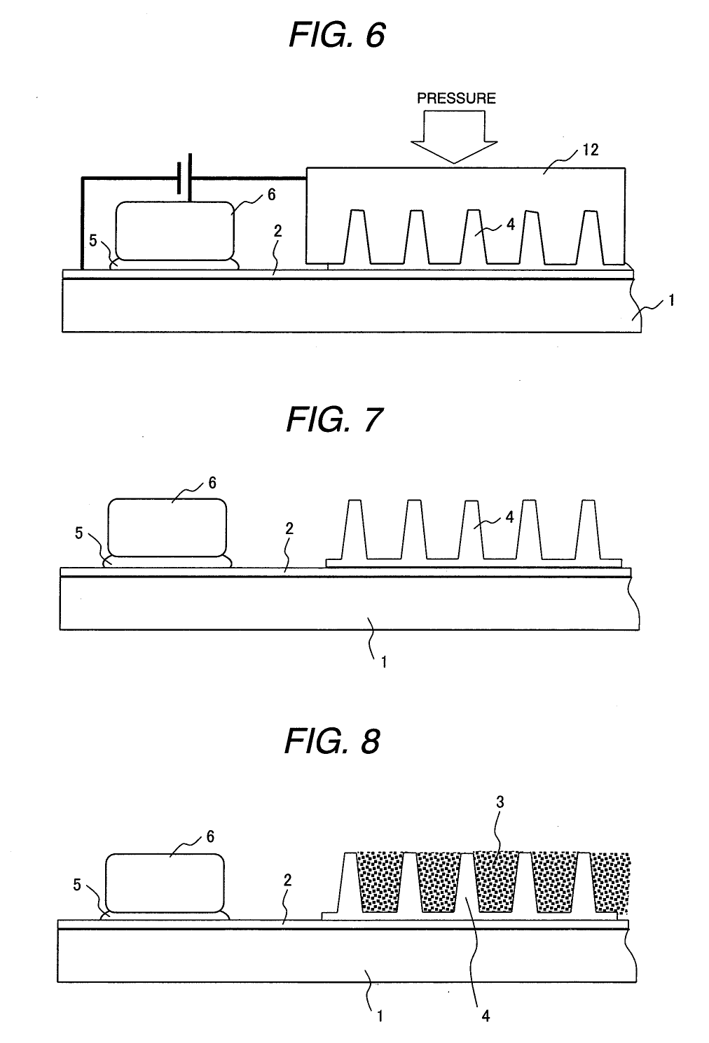

Thereafter, pressure is applied from above and the partition wall 4 is pressed to the die 12 so as to form a male shape. SUS is used for the die in the present embodiment (FIGS. 5 and 6).

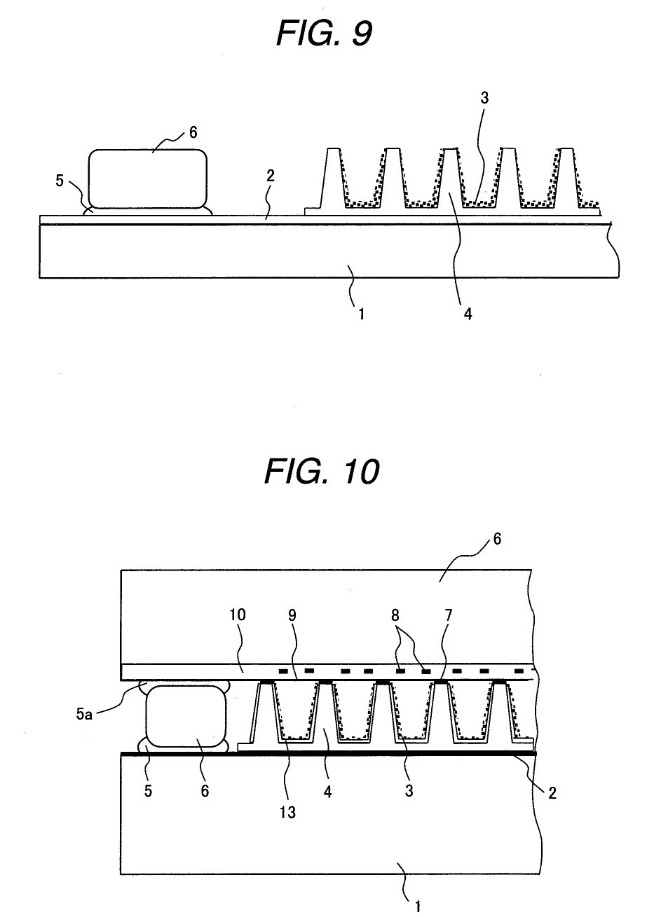

The die is removed slowly during heating so as not to impair the shape of the barrier ribs. Further, the interiors of the barrier ribs are coated with fluorescent materials of three colors R, G, and B (FIG. 8) and baked at 460° C., and thereby such a back plate of a PDP as shown in FIG. 9 is obtained.

Further, the back substrate is encapsulated from above with a separately produced front plate, the interior is evacuated into vacuum and filled with a xenon gas or the like, and thereby the PDP shown in FIG. 1 is obtained.

By such a method, stress does not remain in the back substrate 1 and barrier ribs scarcely having problems such as warping can be formed. The method is a production method of no material loss and low environmental loads in comparison with a conventional sandblasting method or the like. As a material of the barrier ribs 4 applicable to such a production method, glass showing semiconductor-like electron conductivity is effective.

In the present invention, not only the side surfaces of the barrier ribs 4 but also the bottom surfaces of the barrier ribs may be configured with the same material. A dielectric film or the like is formed at the bottom surfaces of the barrier ribs as shown in FIG. 22 in a conventional case but it is possible to integrate the dielectric layer 20 with the barrier ribs 4 in the present invention. This not only makes it possible to eliminate the step of forming the dielectric layer 20 but also is effective in removing electric charge accumulated on the barrier ribs.

Further, in the present embodiment, a PDP wherein a thin film is formed on the side surfaces of barrier ribs is also produced. A schematic sectional view of a PDP wherein a thin film is formed on the side surfaces of barrier ribs is shown in FIG. 10. The reason why a thin film 13 is formed only on the side surfaces of the barrier ribs is, since a fluorescent material 3 is applied to the side surfaces, to direct the light emitted from the fluorescent material 3 to the backside toward the side of the front plate as much as possible and to improve the luminance. Here, when the film is undesirably formed on the upper surface of the front plate, the reflectance of the barrier ribs viewed from the side of the front plate increases and thus the black contrast deteriorates undesirably. Consequently, such a film must be limited only to the side surfaces and the bottom surfaces of the barrier ribs to which fluorescent materials are applied.

In the case of the embodiment shown in FIG. 10, a thin film is formed only on the side surfaces and the bottom surfaces of the barrier ribs and is not formed on the barrier ribs on the side of the front substrate 11. A production method in this case is explained in reference to FIGS. 11 to 14.

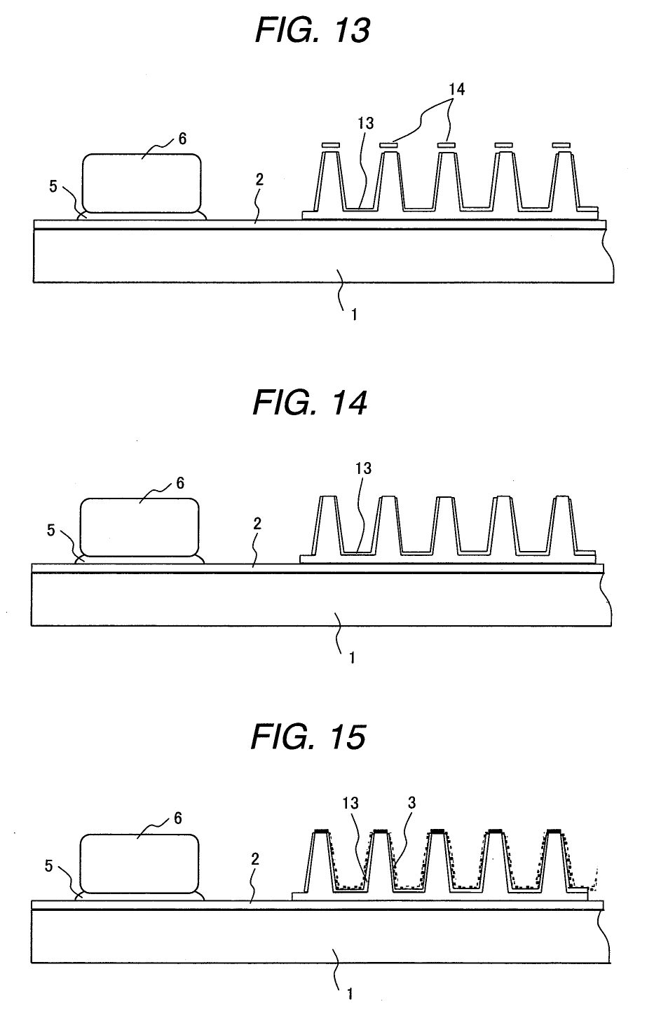

After barrier ribs 4 are formed (corresponding to FIG. 7) in the same way as a PDP wherein a thin film is not formed, a mask 14 for forming a thin film is placed on the upper surface of the barrier ribs (FIG. 11). In the case of forming stripe-shaped barrier ribs for example, such a mask as shown in FIG. 12 is used. After the mask is formed, a thin film 13 is formed by a sputtering method, a vapor deposition method, or another method (FIG. 13). On this occasion, on the upper surface of the barrier ribs, the thin film 13 is not formed since the mask is formed. Thereafter, the mask is removed and, as shown in FIG. 14, a back plate wherein the thin film is formed only in the insides of the barrier ribs is produced.

Further, fluorescent materials are applied and baked in the insides of the barrier ribs (FIG. 15). The back plate is encapsulated from above with a separately produced front plate, an inside gas is evacuated, the interiors are filled with a xenon gas or the like, and thus a plasma display panel is completed.

### Embodiment 2

In the present embodiment, the results of precise studies on tungsten-phosphorus-barium-vanadium-based glass materials are described.

A glass for barrier ribs in the present invention is formed by electrical heating as stated in Embodiment 1 and hence the electrical resistance thereof must be suitable for generating heat by the supply of electricity. Further, in order to prevent the shape from deforming even by baking after the application of florescent materials, it is desirable that the shape does not deform even at 460° C. that is the baking temperature of the florescent materials. Consequently, the glass transition temperature of a glass for barrier ribs is preferably 470° C. or higher. Further, on the occasion of burning in the back substrate 1, it is necessary to be soft to the extent of being workable at a temperature lower than the temperature of soda lime glass that is the material of the back plate.

The glass transition temperature of soda lime glass used for a PDP is about 610° C. and hence a preferable softening temperature is 600° C. or lower. Further, in an ordinary glass material, the softening temperature is about 570° C. when the glass transition temperature is 470° C. and the glass transition temperature is about 500° C. when the softening temperature is 600° C. Consequently, it is desirable that the glass transition temperature of the glass for barrier ribs is in the range of 470° C. to 500° C. and the softening temperature is in the range of 570° C. to 600° C. in the present invention.

Further, since the thermal expansion coefficient of soda lime glass is 80×10⁻⁷/° C. in the measurement temperature range of room temperature to 350° C., a thermal expansion coefficient desirable for not causing breakage or the like even when compression or tensile stress exists to some extent is in the range of 70×10⁻⁷/° C. to 90×10⁻⁷/° C. When a thermal expansion coefficient is less than 70×10⁻⁷/° C., shearing stress occurs in the direction where glass peels off and a partition wall material breaks. On the other hand, when a thermal expansion coefficient exceeds 90×10⁻⁷/C, breakage occurs undesirably in the longitudinal direction of barrier ribs due to tensile stress.

Further, when a partition wall material has electric conductivity, remaining electric charge can be desirably earthed at the time of display but, when the electric resistance is too low, electric charge accumulated preliminarily in the vicinities of display electrodes for the purpose of display is also earthed and hence the response of the display lowers undesirably. The residue of electric charge at the time of display undesirably causes display error, excessive accumulation of electric charge, and resultant abnormal electric discharge.

The volume resistivity of barrier ribs that does not cause such abnormality and allows the state of electric charge in a cell to be properly maintained is in the range of 1×10⁷ to 1×10¹¹ Ωcm.

Further, it goes without saying that, when glass is devitrified due to crystallization or the like, fluidity is hindered when barrier ribs are formed by electrical heating and an appropriate shape is not obtained. Consequently, it is desirable that devitrification is avoided.

It is desirable that the color of the end surfaces, of barrier ribs, touching the upper panel is black in order to further improve black contrast of display.

As glasses that can satisfy the above characteristic, glasses containing oxide of tungsten, phosphorus, barium, and vanadium as the constituent components are produced and the characteristics thereof are evaluated.

Compositions, occurrence of devitrification, thermal expansion coefficients, glass transition temperatures, softening temperatures, appearance colors, and volume resistivities of the studied glass materials are shown in Table

TABLE 1

| | | | | | | Thermal | | | | |
|---|---|---|---|---|---|---|---|---|---|---|
| | | | | | | expansion | | | | Volume |
| | Composition (Wt %) | | | | Existence of | coefficient | Tg | Ts | | resistivity |
| NO. | WO₃ | P₂O₅ | BₐO | V₂O₅ | Devitrification | (×10 ⁻⁷/° C.) | (° C.) | (° C.) | Color | (Ωcm) |
| 1 | 20 | 39 | 22 | 19 | Yes | 81 | 462 | 560 | Black | 2.1 × 10⁷ |
| 2 | 24 | 38 | 20 | 18 | Yes | 80 | 466 | 575 | Black | 9.8 × 10⁷ |
| 3 | 25 | 37 | 20 | 18 | Yes | 79 | 471 | 576 | Black | 8.5 × 10⁷ |
| 4 | 35 | 35 | 15 | 15 | Yes | 75 | 475 | 578 | Black | 7.4 × 10⁷ |
| 5 | 50 | 25 | 15 | 10 | Yes | 74 | 487 | 592 | Black | 7.5 × 10⁷ |
| 6 | 60 | 19 | 12 | 9 | Yes | 72 | 498 | 599 | Black | 6.8 × 10¹⁰ |
| 7 | 61 | 18 | 12 | 9 | Yes | 72 | 502 | 604 | Black | 7.1 × 10¹⁰ |
| 8 | 50 | 10 | 22 | 18 | No | 80 | 457 | 555 | Black | 5.0 × 10⁷ |
| 9 | 46 | 14 | 22 | 18 | No | 79 | 463 | 562 | Black | 4.2 × 10⁷ |
| 10 | 45 | 15 | 22 | 18 | Yes | 81 | 472 | 574 | Black | 8.8 × 10⁷ |
| 11 | 40 | 30 | 12 | 18 | Yes | 75 | 481 | 582 | Black | 8.1 × 10⁷ |
| 12 | 30 | 40 | 15 | 15 | Yes | 72 | 498 | 599 | Black | 1.4 × 10⁸ |
| 13 | 29 | 41 | 15 | 15 | Yes | 70 | 503 | 604 | Black | 2.2 × 10⁸ |
| 14 | 37 | 38 | 6 | 19 | Yes | 65 | 472 | 579 | Black | 4.3 × 10⁷ |
| 15 | 39 | 38 | 8 | 15 | Yes | 71 | 473 | 572 | Black | 1.2 × 10⁷ |
| 16 | 30 | 30 | 20 | 20 | Yes | 80 | 476 | 579 | Black | 1.3 × 10⁹ |
| 17 | 30 | 25 | 30 | 15 | Yes | 89 | 480 | 590 | Black | 6.8 × 10⁷ |
| 18 | 29 | 25 | 31 | 15 | Yes | 97 | 489 | 595 | Black | 6.1 × 10⁷ |
| 19 | 40 | 30 | 24 | 6 | Yes | 82 | 481 | 583 | Black | 1.2 × 10¹² |
| 20 | 42 | 30 | 20 | 8 | Yes | 80 | 480 | 581 | Black | 8.9 × 10¹¹ |
| 21 | 40 | 30 | 20 | 10 | Yes | 79 | 476 | 572 | Black | 3.5 × 10⁸ |
| 22 | 40 | 25 | 15 | 20 | Yes | 75 | 475 | 576 | Black | 1.2 × 10⁷ |
| 23 | 40 | 24 | 15 | 21 | Yes | 75 | 472 | 571 | Black | 8.2 × 10⁶ |

In Table 1, a composition represents an analysis result of a glass composition and the oxides are expressed by the oxide equivalents of WO₃, P₂O₅, BaO, and V₂O₅. Here, a composition is obtained by analyzing a produced glass by the ICPS (Inductively Coupled Plasma Emission Spectrometry) method.

Meanwhile, a glass is produced by blending the materials of the elements so as to constitute an intended glass composition, putting the material powder into a platinum-made crucible, heating and melting the material powder at 1,400° C. for two hours in an electric furnace, and thereafter rapidly cooling the material from the temperature. While the material is melted in the electric furnace, a platinum-made stirring rod is inserted into the crucible and the molten material is stirred. After the melting, the material is poured in a graphite tool preliminarily heated to 400° C. Then the material is heated again to 800° C., retained for two hours, and slowly cooled at a cooling rate of 0.5° C./min., and thereby a glass block with no strain is obtained.

Here, with regard to the materials of the constituent oxides, except the fact that barium phosphate is used as the material of barium, an oxide material including WO₃, P₂O₅, and V₂O₅ is used.

Further, with regard to the existence of devitrification in Table 1, after a glass is melted and relieved from strain, a button flow test is carried out by putting the cullet of the glass on a borosilicate glass substrate and heating the cullet again to 800° C. The surface is observed visually and with an optical microscope, and a case where crystallization is recognized is defined as NO and a case where crystallization is not recognized and the natural clear surface of the glass is observed is defined as YES.

Further, a volume resistivity is measured by: cutting out a glass stick in the size of 1 mm×10 mm×3 mm from a glass block; forming Pt electrodes by vapor-deposition on both the end surfaces of 1 mm×10 mm so as to set the distance between the electrodes at 3 mm; inserting the whole glass stick including the electrodes into a thermostatic bath; once heating the glass stick to 125° C. for removing moisture; and thereafter cooling the glass stick again to 25° C. A resistance is obtained by applying a DC voltage of 500 V and measuring the electric current flowing at the time.

In Table 1, Nos. 1 to 7 are the cases where the amount of WO₃ is varied and the physical properties are evaluated. The content of WO₃ is increased as the sample number increases from No. 1. A feature in those cases is that the glass transition temperature and the softening temperature increase in proportion to the increase of the WO₃ content. In the glasses of Nos. 1 and 2, Tg is lower than 470° C., hence the possibility of causing deformation at 460° C. that is the fluorescent material baking temperature is high, and thus the glasses have a problem. In the cases of Nos. 3 to 6, all the parameters are good and the glasses are suitable as the glass material for barrier ribs. Then in the glass of No. 7, the softening temperature exceeds 600° C. and hence it is found that glass forming is impossible unless the glass is heated to a temperature not lower than the glass transition temperature of a soda lime glass that is the material of the back plate.

From the above results, a preferable content of WO₃ is in the range of 25 wt % to 60 wt %. When a WO₃ content is less than 25 wt %, the glass transition temperature is low and there is the possibility of causing the drawback of deformation in the fluorescent material baking step. In contrast, when a WO₃ content exceeds 60 wt %, the softening temperature exceeds 600° C. and hence the back plate glass material may be deteriorated undesirably when the glass is formed and baked on a substrate.

Successively, the glasses of the samples Nos. 8 to 13 are produced while the content of P₂O₅ is varied. As shown in Nos. 8 and 9, when the content of P₂O₅ is small, an aspect of crystallization is undesirably observed on the glass surfaces. The glass of No. 9 having a higher P₂O₅ content is good but the indication of crystallization is observed although it is very slightly. In the glass of No. 10 containing P₂O₅ by 15 wt %, such an aspect of crystallization is not seen and a clear glass surface can be obtained.

From the above results, it is found that a preferable P₂O₅ content is not less than 15 wt %. When a P₂O₅ content is increased, such indication of crystallization disappears and it is observed that Tg and Ts tend to increase. In the glasses of Nos. 10 to 12 produced by increasing the P₂O₅ content, both Tg and Ts show good values. In the glass of No. 13 containing P₂O₅ by 41 wt % however, Ts exceeds 600° C. and hence the back plate is likely to deform in processing.

From the above results, a preferable P₂O₅ content is in the range of not less than 15 wt % to not more than 40 wt %. When the P₂O₅ content is less than 15 wt %, the glass devitrifies undesirably. In contrast, when the P₂O₅ content exceeds 40 wt %, the softening temperature increases excessively.

Successively, the glasses of Nos. 14 to 18 are produced and the content of BaO is studied. The feature shown in the glasses is that, when a BaO content increases, the thermal expansion coefficient of the glass also increases. In the glass of No. 14 containing BaO by 6 wt %, the thermal expansion coefficient is 65×10⁻⁷/° C. that is too low as a back plate glass, cracks of an exfoliated state are likely to be generated undesirably after forming. In the glasses of Nos. 15 to 18, the thermal expansion coefficients are as good as 71 to 89×10⁻⁷/° C. In the glass of No. 18 however, the thermal expansion coefficient is 97×10⁻⁷/° C. and excessive, and hence tensile stress incurred from the back plate glass is large in the heat treatment step and cracks are likely to occur undesirably in the longitudinal direction.

From the above results, a preferable BaO content is in the range of 8 wt % to 30 wt %. When a BaO content is less than 8 wt %, the thermal expansion coefficient is too low and cracks occur undesirably in the exfoliation direction. In contrast, when a BaO content exceeds 30 wt %, the thermal expansion coefficient increases excessively and hence breakage caused by cracks in the longitudinal direction occurs undesirably.

Further, in the glasses of Nos. 19 to 23, the content of V₂O₅ is studied. The situation where the volume resistivity considerably lowers as the content of V₂O₅ increases is observed. In the glass of No. 19 containing V₂O₅ by 6 wt %, the volume resistivity is as high as 1.2×10¹² Ωcm, and it is found that the remaining electric charge in the panel is hardly earthed and that may cause abnormal electric discharge.

In the glasses of Nos. 20 to 22, the volume resistivity is in the range of 1.0×10¹² to 1.0×10⁷ Ωcm and the possibility that abnormal discharge in the panel is observed is small and the performance is good. In contrast, in the glass of No. 23 containing V₂O₅ by 21 wt %, the volume resistivity is lower than 1.0×10⁷ Ωcm. In this case, there is the possibility that even the accumulated electric charge applied for marking display in the vicinities of the display electrodes on the top panel is undesirably earthed and response of the display lowers extremely. Consequently, it is found that the glass of No. 23 is not desirable.

From the above results, a preferable V₂O₅ content is in the range of 8 wt % to 20 wt %. When a V₂O₅ content is less than 8 wt %, the resistance increases and that causes abnormal discharge undesirably. In contrast, when V₂O₅ content exceeds 20 wt %, the resistance lowers excessively and the response of display lowers undesirably.

The color of the appearance of all the glasses shown in Table 1 is black and the black contrast can be improved desirably.

### Embodiment 3

Successively, various additional elements are studied in order to improve the weather resistance of a tungsten-phosphorus-barium-vanadium-based glass. The results are shown in Table 2.

TABLE 2

| | | | | | | | | | | | | | Thermal | | | | |
|---|---|---|---|---|---|---|---|---|---|---|---|---|---|---|---|---|---|
| | | | | | | | | | | | Ex- | Dis- | expan- | | | | |
| | | | | | | | | | | | istence | solved | sion | | | | |
| | | | | | | | | | | | of | amount | co- | | | | Volume |
| | | | | | | | | | | | de- | in | efficient | | | | resis- |
| | Composition (Wt %) | | | | | | | | | | vitrifi- | water | (×10⁻⁷/ | Tg | TS | | tivity |
| No. | Wo₃ | P₂O₅ | BaO | V₂O₅ | MoO₃ | Cr₂O₃ | HfO₂ | ZrO₂ | Al₂O₃ | Gd₂O₃ | cation | (%) | ° C.) | (° C.) | (° C.) | Color | (Ωcm) |
| 24 | 35 | 30 | 15 | 20 | — | — | — | — | — | — | Yes | 0.5 | 81 | 460 | 561 | Black | 1.5 × 10⁶ |
| 25 | 35 | 30 | 15 | 15 | 5 | — | — | — | — | — | Yes | 0.3 | 82 | 462 | 560 | Black | 2.1 × 10⁷ |
| 26 | 35 | 28 | 15 | 15 | 7 | — | — | — | — | — | Yes | 0.6 | 81 | 465 | 564 | Black | 2.1 × 10⁷ |
| 27 | 35 | 25 | 15 | 15 | 10 | — | — | — | — | — | Yes | 0.8 | 80 | 472 | 573 | Black | 2.5 × 10⁷ |
| 28 | 40 | 24 | 16 | 17 | — | 3 | — | — | — | — | Yes | 0.3 | 75 | 477 | 572 | Black | 1.2 × 10⁷ |
| 29 | 38 | 24 | 16 | 17 | — | 5 | — | — | — | — | Yes | 0.1 | 74 | 485 | 589 | Black | 1.1 × 10⁷ |
| 30 | 39 | 24 | 16 | 15 | — | 6 | — | — | — | — | No | 0.1 | 72 | 496 | 599 | Black | 3.3 × 10⁷ |
| 31 | 40 | 24 | 18 | 15 | — | — | 3 | — | — | — | Yes | 0.2 | 72 | 487 | 587 | Black | 3.6 × 10⁷ |
| 32 | 40 | 24 | 18 | 14 | — | — | 4 | | — | — | No | 0.1 | 80 | 475 | 575 | Black | 4.8 × 10⁷ |
| 33 | 40 | 24 | 18 | 15 | — | — | — | 3 | — | — | Yes | 0.2 | 71 | 487 | 587 | Black | 3.6 × 10⁷ |
| 34 | 40 | 24 | 18 | 14 | — | — | — | 4 | — | — | No | 0.1 | 79 | 476 | 577 | Black | 4.8 × 10⁷ |
| 35 | 40 | 24 | 18 | 15 | — | — | — | — | 3 | — | Yes | 0.03 | 79 | 472 | 571 | Black | 5.7 × 10⁷ |
| 36 | 40 | 24 | 18 | 14 | — | — | — | — | 4 | — | No | 0.02 | 81 | 472 | 574 | Black | 4.5 × 10⁷ |
| 37 | 40 | 24 | 18 | 15 | — | — | — | — | — | 3 | Yes | 0.01 | 75 | 481 | 582 | Black | 5.6 × 10⁷ |
| 38 | 40 | 24 | 18 | 14 | — | — | — | — | — | 4 | No | 0.02 | 72 | 480 | 583 | Black | 4.2 × 10⁷ |

Six kinds of oxides, MoO₃, Cr₂O₃, HfO₂, ZrO₂, Al₂O₃, and Gd₂O₃, are studied in order to improve weather resistance. In Table 2, a dissolved amount in water is obtained by: dipping a glass block (about 4 g) of 10 cubic millimeters in warm water of 80° C. for 24 hours; inserting and sufficiently drying the glass block in a dryer of 120° C. for 5 hours; measuring the weights of the glass block before and after the dipping up to the unit of 0.1 mg; and standardizing the difference by the weight before the dipping and computing the dissolved amount.

No. 24 represents a quaternary glass composition of a WO₃—P₂O₅—BaO-V₂O₅ system that does not include the above oxides, and the weight reduction of 0.5% is recognized. In contrast, in the glass containing MoO₃, it is found that the dissolved amount decreases with MoO₃ of 5 wt % or less but increases with an amount exceeding 5 wt %.

When Cr₂O₃, HfO₂, ZrO₂, Al₂O₃, or Gd₂O₃ is contained, water resistance improves considerably but, if the content is excessive, devitrification occurs undesirably. More specifically, water resistance improves and devitrification is not seen when Cr₂O₃ is 5 wt % or less, but devitrification is observed when Cr₂O₃ exceeds 5 wt %. Further, in any of HfO₂, ZrO₂, Al₂O₃, and Gd₂O₃, water resistance improves and a good glass is produced when the content is 3 wt % or less, but devitrification is observed undesirably when the content exceeds 3 wt %. Other characteristics including a thermal expansion coefficient, a glass transition temperature, a softening temperature, color, and a volume resistivity are good.

From the above results, in order to improve the weather resistance of a glass, it is possible to contain MoO₃ in the range of 0 to 5 wt %, Cr₂O₃ in the range of 0 to 5 wt %, ZrO₂ in the range of 0 to 3 wt %, HfO₂ in the range of 0 to 3 wt %, Gd₂O₃ in the range of 0 to 3 wt %, and Al₂O₃ in the range of 0 to 3 wt %. When each of the oxides exceeds the respective range, the effect of improving weather resistance disappears in the case of MoO₃, and crystallization occurs undesirably in the cases of the other oxides.

### Embodiment 4

Successively, a filler is added to a glass shown on Table 1 and the effect is verified. In the present embodiment, the studies are carried out by using alumina (Al₂O₃) that has a good thermal expansion coefficient and can be added to a tungsten-phosphorus-barium-vanadium-based glass with good sinterability. The colors and the volume resistivities of glass materials baked after Al₂O₃ is added as the filler are shown on Table 3. The average diameter of the added Al₂O₃ particles is set at 2 μm.

TABLE 3

| | Glass | | | | Filler | | | |
|---|---|---|---|---|---|---|---|---|
| | composition | | | | | Addition | | |
| | (wt %) | | | | | amount | | Volume resistivity |
| No. | WO₃ | P₂O₅ | BaO | V₂O₅ | Component | (vol %) | Color | (Ωcm) |
| 39 | 35 | 35 | 15 | 15 | Al₂O₃ | 20 | Black | 8.1 × 10⁷ |
| 40 | 35 | 35 | 15 | 15 | Al₂O₃ | 28 | Black | 9.8 × 10⁷ |
| 41 | 35 | 35 | 15 | 15 | Al₂O₃ | 30 | Black | 1.1 × 10⁸ |
| 42 | 35 | 35 | 15 | 15 | Al₂O₃ | 35 | Black | 3.2 × 10⁸ |
| 43 | 35 | 35 | 15 | 15 | Al₂O₃ | 40 | Gray | 6.4 × 10⁸ |
| 44 | 35 | 35 | 15 | 15 | Al₂O₃ | 50 | Gray | 2.8 × 10⁹ |
| 45 | 35 | 35 | 15 | 15 | Al₂O₃ | 60 | Gray | 7.1 × 10¹⁰ |
| 46 | 35 | 35 | 15 | 15 | Al₂O₃ | 70 | Gray | 8.9 × 10¹¹ |
| 47 | 35 | 35 | 15 | 15 | Al₂O₃ | 72 | Gray | 1.3 × 10¹² |

In Table 3, as the amount of the added Al₂O₃ filler increases, the color of appearance comes close to gray and the volume resistivity increases. When the filler amount does not exceed 70 vol %, the volume resistivity is desirably not more than 1.0×10¹² Ωcm. However when the filler amount exceeds 70 vol %, the volume resistivity is undesirably 1.3×10¹² Ωcm. Further, when the added filler amount is excessive, the fluidity of glass is hindered undesirably when barrier ribs are formed by an electric heating method.

From the above results, good barrier ribs are obtained even when a filler is added but it is desirable that the filler amount is not more than 70 vol %.

### Embodiment 5

Successively, PDPs shown in FIGS. 1 and 10 are produced by using the glasses having the compositions studied in Embodiments 2 to 4 as the barrier ribs and the black contrast and the white luminance are evaluated when the glass shown in Embodiment 1 is used as the barrier ribs. Here, in the present embodiment, in order to increase the white luminance, the PDP is configured so as to increase the luminance by forming a reflective film on the surfaces of barrier ribs touching the fluorescent material and reflecting the light emitted backward to the front side as shown in FIG. 10.

Here, FIG. 1 is a schematic sectional view of a PDP wherein a thin film is not formed and FIG. 10 is a schematic sectional view of a PDP wherein a thin film is formed.

The configurations of the studied barrier ribs and thin films, the refractive indexes of thin films of the barrier ribs, the refractive indexes of substrates at the wavelength of 530 nm, the reflectances, the absorptances, and the transmittances in the cases of forming and not forming thin films on glass substrates at the wavelength of 530 nm, and the black contrast and the white luminance of the PDP shown in FIG. 1 or 10 are shown on Table 4.

In Table 4, the values of the basic optical constants including a refractive index, a reflectance, an absorptance, and a transmittance are measured by producing a mirror-finished substrate thin piece of 20 mm square×0.5 mm thickness and forming a thin film on the substrate thin piece by a sputtering method before the panels shown in FIGS. 1 and 10 are produced.

Further, a relative black contrast and a relative white luminance shown in Table 4 are evaluated as panel characteristics after a PDP shown in FIG. 1 or 10 is produced. The relative black contrast is obtained by showing the luminance of the light emitted from a screen when black image is displayed all over the screen while voltage is applied as a relative value when the luminance of a PDP shown in FIG. 1 produced by using the barrier ribs of a bismuth-based glass of the sample No. 48 is defined as 1. Further, the relative white luminance is obtained by showing the luminance when all over the screen is fully displayed in white as a relative value when the luminance of a PDP shown in FIG. 1 produced by using the barrier ribs of a bismuth-based glass of the sample No. 48 is defined as 1.

TABLE 4

| | | | Thin film refractive | | |
|---|---|---|---|---|---|
| | Kind of | Composition of partition wall | index at each wavelength | | |
| No. | thin film | glass material (wt %) | 400 nm | 530 nm | 650 nm |
| 48 | — | 60Bi₂O₃—12B₂O₃—6SiO₃—15Na₂O—7BaO | — | — | — |
| 49 | — | 35WO₃—35P₂O₅—15BaO—15V₂O₅ | — | — | — |
| 50 | Fe₂O₃ | 35WO₃—35P₂O₅—15BaO—15V₂O₅ | 2.8 | 3.0 | 2.9 |
| 51 | 70Fe₂O₃—30Ga₂O₃ | 35WO₃—35P₂O₅—15BaO—15V₂O₅ | 2.6 | 2.5 | 2.4 |
| 52 | 50Fe₂O₃—50Ga₂O₃ | 35WO₃—35P₂O₅—15BaO—15V₂O₅ | 2.3 | 2.2 | 2.1 |
| 53 | 30Fe₂O₃—70Ga₂O₃ | 35WO₃—35P₂O₅—15BaO—15V₂O₅ | 2.2 | 2.0 | 1.9 |
| 54 | Ga₂O₃ | 35WO₃—35P₂O₅—15BaO—15V₂O₅ | 1.8 | 1.7 | 1.6 |
| 55 | TaN | 35WO₃—35P₂O₅—15BaO—15V₂O₅ | 3.8 | 3.6 | 3.4 |
| 56 | Si | 35WO₃—35P₂O₅—15BaO—15V₂O₅ | 4.2 | 4.0 | 3.7 |
| 57 | Ge | 35WO₃—35P₂O₅—15BaO—15V₂O₅ | 4.3 | 4.2 | 3.9 |
| 58 | Fe₂O₃ | 60Bi₂O₃—12B₂O₃—6SiO₃—15Na₂O—7BaO | 2.8 | 3.0 | 2.9 |
| 59 | — | 35WO₃—35P₂O₅—15BaO—15V₂O₅ + 50 Volume | — | — | — |
| | | % Al₂O₃ | | | |
| 60 | Fe₂O₃ | 35WO₃—35P₂O₅—15BaO—15V₂O₅ + 50 Volume | 2.8 | 3.0 | 2.9 |
| | | Al₂O₃ | | | |
| 61 | Cr₂O₃ | 35WO₃—35P₂O₅—15BaO—15V₂O₅ + 50 Volume | 2.7 | 3.1 | 2.7 |
| | | % Al₂O₃ | | | |

| | Refractive index | | | | Relative | Relative |
|---|---|---|---|---|---|---|
| | of substrate; | Reflectance | Absorptance | Transmittance | black | white |
| No. | wavelength = 530 nm | Wavelength = 530 nm | | | contrast | luminance |
| 48 | 2.11 | 12.0 | 2.0 | 86.0 | 1.0 | 1.0 |
| 49 | 1.78 | 10.0 | 90.0 | 0.0 | 0.5 | 1.0 |
| 50 | 1.78 | 23.0 | 77.0 | 0.0 | 0.4 | 1.3 |
| 51 | 1.78 | 22.0 | 78.0 | 0.0 | 0.5 | 1.2 |
| 52 | 1.78 | 20.5 | 79.5 | 0.0 | 0.6 | 1.1 |
| 53 | 1.78 | 12.0 | 88.0 | 0.0 | 0.5 | 1.0 |
| 54 | 1.78 | 10.0 | 90.0 | 0.0 | 0.5 | 1.0 |
| 55 | 1.78 | 25.0 | 75.0 | 0.0 | 0.4 | 1.4 |
| 56 | 1.78 | 28.0 | 72.0 | 0.0 | 0.5 | 1.4 |
| 57 | 1.78 | 32.0 | 68.0 | 0.0 | 0.5 | 1.6 |
| 58 | 2.11 | 26.0 | 12.0 | 62.0 | 1.1 | 1.5 |
| 59 | 1.56 | 14.0 | 86.0 | 0.0 | 0.7 | 1.3 |
| 60 | 1.56 | 27.0 | 73.0 | 0.0 | 0.7 | 1.6 |
| 61 | 1.56 | 25.0 | 75.0 | 0.0 | 0.7 | 1.6 |

In the sputtering method for producing a thin film, a sputtering gas including Ar and 5% O₂, oxide targets of various compositions, and an RF electric power supply are used in order to form an Fe₂O₃, Ga₂O₃, Fe₂O₃—Ga₂O₃, or Cr₂O₃-based thin film. The film thickness is varied in the range of 20 to 200 nm. When a TaN film is formed, a Ta target is used and reactive sputtering is adopted in an atmosphere of Ar and 5% N₂. The sputtering power is set at 500 W, the target size at 152.4 mmφ, the ultimate pressure at 4.0×10⁻⁵ Pa, and the gas pressure in film forming at 0.7 Pa.

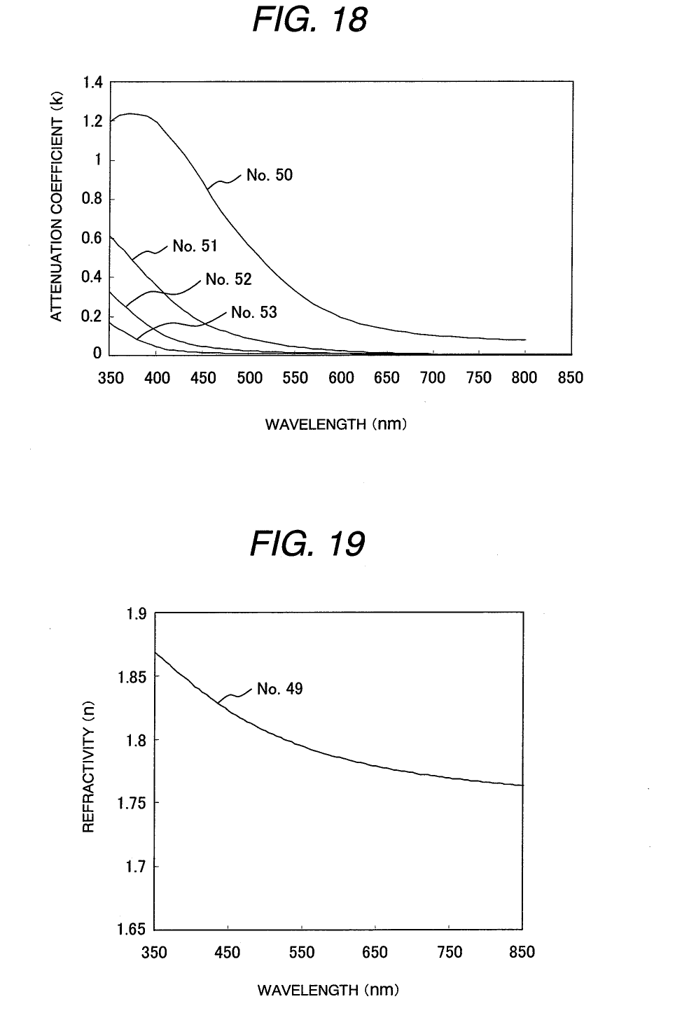

The refractive indexes and the attenuation coefficients of the obtained thin films and base materials are measured with a spectroscopic ellipsometer. A tungsten lamp is used as the light source for the measurement and the wavelength for the measurement is in the range of 350 to 850 nm. The wavelength dispersion characteristics of the refractive indexes and the attenuation coefficients of Fe₂O₃— and Fe₂O₃—Ga₂O₃-based thin films of the samples Nos. 50 to 53 are shown in FIGS. 17 and 18.

In the case of the simple Fe₂O₃ thin film of the sample No. 50, the refractive index is as high as 2.8 or more all over the visible light region of 400 to 800 nm in wavelength. When Ga₂O₃ is added, as the amount of added Ga₂O₃ increases, both the refractive index and the attenuation coefficient lower in the visible light region. In the case of 70Fe₂O₃—30Ga₂O₃ of the sample No. 51, the refractive index is 2.4 or more. In contrast, in the cases of the samples Nos. 52 and 53, the refractive index further lowers in the visible light region and the lowest refractive index in the wavelength region is as low as 2.1 to 2.0.

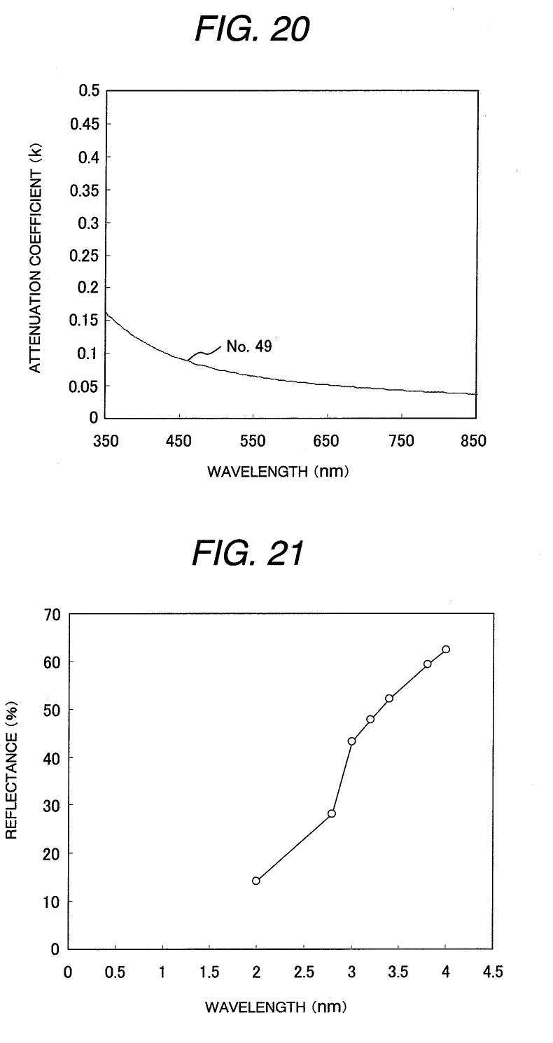

Further, the refractive index and the attenuation coefficient of a WO₃—P₂O₅—BaO-V₂O₅-based glass substrate of the sample No. 49 are shown in FIGS. 19 and 20. The refractive index of the WO₃—P₂O₅—BaO-V₂O₅-based glass substrate lowers as the wavelength increases and is about 1.75 when the wavelength is 800 nm.

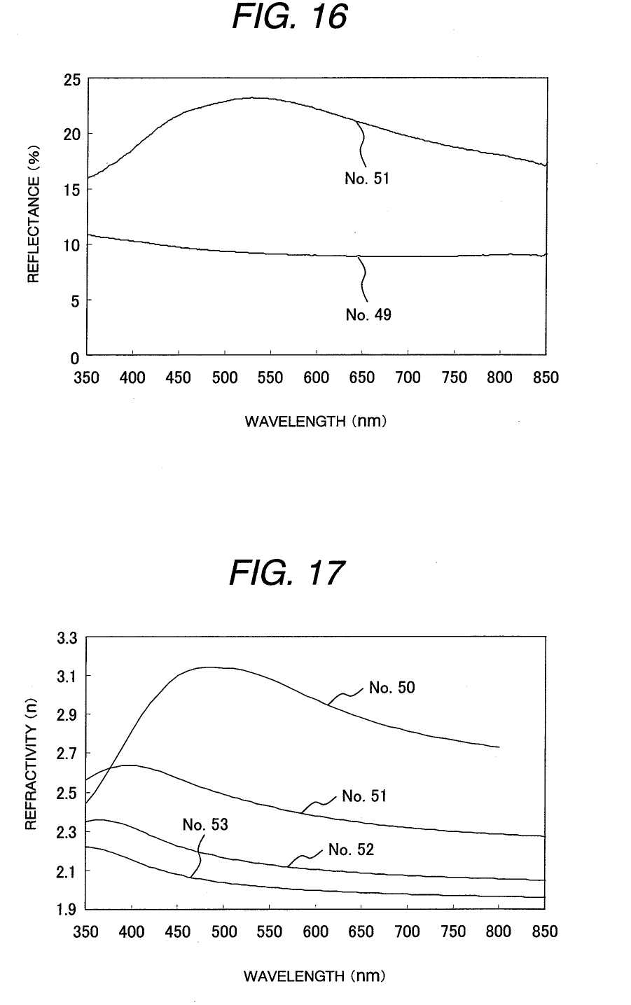

The reflectances of the materials shown in Table 4 are measured in the visible light region of 400 to 800 nm in wavelength. A spectrophotometer (U-4100) made by Hitachi High-Technologies Corporation is used for the measurement. The spectral reflectance curves of the samples Nos. 49 and 51 are shown in FIG. 16 as examples. It has been found that, whereas the reflectance in the visible light wavelength region is about 9% to 11% in the case of the WO₃—P₂O₅—BaO-V₂O₅-based glass base material of the sample No. 49, the reflectance increases to 16% to 23% in the case of forming a 70Fe₂O₃—30Ga₂O₃ thin film of the sample No. 51.

Firstly, the PDP wherein a thin film is not formed as shown in FIG. 1 is evaluated. The sample No. 48 is produced by using a low-temperature softening glass mainly composed of bismuth as the base material. The sample of No. 49 is an example produced by using a WO₃—P₂O₅—BaO-V₂O₅-based glass as the base material, and the color of the top surface of the barrier ribs is black and hence the blackness of the whole screen deepens and the relative black contrast remarkably improves up to 0.5.

In contrast, the relative white luminance is not changed since the luminous efficiency of the fluorescent material is the same. Further, in the case of the sample No. 59 wherein a base material produced by adding Al₂O₃ by 50 vol % to a WO₃—P₂O₅—BaO-V₂O₅-based glass is used, the reflectance of Al₂O₃ is high and hence the reflectance at the wavelength of 530 nm improves by 4%. Further, the relative black contrast tends to be whitish to the extent of the inclusion of Al₂O₃ into the base material and increases to 0.7. However, the reflectance of the back surface of the fluorescent material improves and hence the relative white luminance increases to 1.1 by about 10%.

As stated above, when a tungsten-phosphorus-barium-vanadium-based glass produced in the present embodiment is used, the black contrast remarkably improves in comparison with the case of using a conventional bismuth-based glass. Further, when an Al₂O₃ filler is added to the glass, although the effect of improving the black contrast deteriorates to some extent, the black contrast is still better than that of a conventional glass and the white luminance further improves desirably.

Successively, the evaluation result of a plasma display panel of the shape shown in FIG. 10 wherein a thin film is formed on the base material is described.

As shown in Table 4, as the refractive index of a used material increases, the reflectance also increases. The relationship of a reflectance with a refractive index when various kinds of thin films having different refractive indexes are applied to the substrate of the sample No. 49 is shown in FIG. 21. In the figure, as a representative case, the case where the wavelength is 530 nm is shown. It is understood that, as the refractive index increases, the reflectance also increases. Here, the film thickness of each thin film is determined in response to the refractive index thereof so as to be able to obtain the maximum reflectance.

It is obvious from FIG. 21 that, when the WO₃—P₂O₅—BaO-V₂O₅-based glass of the sample No. 49 is used as the base material having the refractive index of 1.78, it is necessary to set the refractive index at 2.2 or more in order to obtain a reflectance of 20% at the wavelength of 530 nm. Further, it is understood that it is necessary to set the refractive index of a thin film at 3.3 or more in order to obtain a reflectance of 50% or more.

If the relationship between a reflectance and a relative black contrast in FIG. 4 is referred to, it is understood that the relative white luminance remarkably improves up to 1.3 by about 30% when the reflectance is 23% like the sample No. 50. Further, it is also understood that the white luminance improves by about 10% when the reflectance is 20% like the sample No. 52.

However, when the reflectance is 12% or less like the samples Nos. 53 and 54, the relative white luminance is 1.0 and the effect of improving luminance is not seen.

Further, when a thin film of TaN, Si, or Ge having a high refractive index is used too, the relative white luminance improves remarkably up to 1.4 to 1.6. Furthermore, it is understood that, when a bismuth-based glass is used as the base material like the sample No. 58 too, by forming Fe₂O₃ as a thin film, the reflectance improves and the relative white luminance improves up to 1.5 by 50% in comparison with the sample No. 48 wherein a thin film is not formed.

Further, in the case of the sample No. 60 or 61 wherein a WO₃—P₂O₅—BaO-V₂O₅-based glass to which an Al₂O₃ filler is added by 50 vol % is used as the base material and Fe₂O₃ or Cr₂O₃ is formed on the side surfaces of the barrier ribs, the relative black contrast is about 0.7 like the case of using only the base material, but the white luminance improves up to 1.6.

As stated above, by forming a thin film of a high refractive index on the side surfaces of barrier ribs, it is possible to increase luminance. It is desirable to select the material used for the thin film from among iron oxide, chromium oxide, composite oxide of iron and gallium, tantalum nitride, silicon, and germanium.

What is claimed is:

1. A plasma display panel comprising a front substrate and a back substrate formed opposite each other and bonded to each other at the peripheries, electrodes formed on the front substrate, a dielectric layer formed on the electrodes, a protective layer formed on the dielectric layer, another electrode and another dielectric layer formed on the back substrate, barrier ribs to keep spaces between the front substrate and the back substrate, and fluorescent materials packed in the spaces formed by the barrier ribs, the front substrate, and the back substrate, wherein the barrier ribs include glass at least containing oxide of tungsten, phosphorus, barium, and vanadium.

2. The plasma display panel according to claim 1, wherein the electrical resistivity of the barrier ribs is in the range of 10⁷ to 10¹¹ Ωcm.

3. The plasma display panel according to claim 1, wherein the height of the barrier ribs is in the range of 100 μm to 500 μm.

4. The plasma display panel according to claim 1, wherein the barrier ribs include glass containing oxide of 25 to 60 wt % WO₃, 15 to 40 wt % P₂O₅, 8 to 30 wt % BaO, and 8 to 20 wt % V₂O₅ in oxide equivalent.

5. The plasma display panel according to claim 4, wherein the barrier ribs include the glass further containing 0 to 5 wt % MoO₃, 0 to 5 wt % Cr₂O₃, 0 to 10 wt % ZrO₂, 0 to 3 wt % HfO₂, 0 to 3 wt % Gd₂O₃, and 0 to 3 wt % Al₂O₃ in oxide equivalent.

6. The plasma display panel according to claim 1, wherein: the barrier ribs include a base material and a thin film formed on the side surfaces thereof; and the thin film includes at least one kind selected from among iron oxide, chromium oxide, composite oxide of iron and gallium, tantalum nitride, silicon, and germanium.

7. The plasma display panel according to claim 6, wherein the refractive index of the thin film is 2.3 or more in the wavelength region of 400 nm to 800 nm.

8. A plasma display panel comprising a front substrate and a back substrate formed opposite each other and bonded to each other at the peripheries, electrodes formed on the front substrate, a dielectric layer formed on the electrodes, a protective layer formed on the dielectric layer, another electrode and another dielectric layer formed on the back substrate, barrier ribs to keep spaces between the front substrate and the back substrate, and fluorescent materials packed in the spaces formed by the barrier ribs, the front substrate, and the back substrate, wherein: the barrier ribs include a base material and a thin film formed on the side surfaces thereof; and the thin film includes at least one kind selected from among iron oxide, chromium oxide, composite oxide of iron and gallium, tantalum nitride, silicon, and germanium.

9. A plasma display panel comprising a front substrate and a back substrate formed opposite each other and bonded to each other at the peripheries, electrodes formed on the front substrate, a dielectric layer formed on the electrodes, a protective layer formed on the dielectric layer, another electrode and another dielectric layer formed on the back substrate, barrier ribs to keep spaces between the front substrate and the back substrate, and fluorescent materials packed in the spaces formed by the barrier ribs, the front substrate, and the back substrate, wherein the bottom surface and the side surface of each of the barrier ribs are integrated.

10. The plasma display panel according to claim 9, wherein the barrier ribs are formed into a lattice pattern to form pixels.

11. The plasma display panel according to claim 9, wherein: a thin film is formed on the bottom surface and the side surface of each of the barrier ribs; and the thin film includes at least one kind selected from among iron oxide, chromium oxide, composite oxide of iron and gallium, tantalum nitride, silicon, and germanium.

12. A method for producing a plasma display panel, the method comprising the steps of: forming a glass thick film at least containing oxide of tungsten, phosphorus, barium, and vanadium on a back plate; and transcribing a partition wall shape on the glass by pressing a die, which is formed into the female shape of the barrier ribs and can be heated by electrification, against the glass.

13. The method for producing a plasma display panel according to claim 12, the method, after the step of transcribing a partition wall shape on the glass, comprising the steps of further: forming a mask on the top end surfaces of the barrier ribs; and removing the mask after a thin film is formed on the inner surfaces of the barrier ribs.
